(19) United States
(12) Patent Application Publication
(10) Pub. No.: US 2007/0144365 A1
(43) Pub. Date: Jun. 28, 2007

(54) METHOD AND SYSTEM FOR PRINTING IDENTIFICATION MARKS

(76) Inventors: DANA PULVINO, Crystal Lake, IL (US); ROBERT HITCHCOCK, West Chicago, IL (US)

Correspondence Address: CARDINAL LAW GROUP;Suite 2000, 1603 Orrington Avenue, Evanston, IL, 60201, US

(21) Appl. No.: 11/617,513

(22) Filed: Dec. 28, 2006

Related U.S. Application Data
(60) Provisional application No. 60/754,457, filed on Dec. 28, 2005.

(51) Int. Cl. B41F 17/00

(52) U.S. Cl. 101/41

(57) ABSTRACT

A method of applying an identification mark to a surface of a workpiece by mixing a taggant with a pad printing ink in predetermined proportions and applying the pad printing ink with the taggant included to the surface of the workpiece. A method of applying an identification mark to a surface of a workpiece includes receiving pad printing ink including a taggant and applying the pad printing ink with the taggant included to the surface of the workpiece.

### RELATED APPLICATIONS

This application claims the benefit of U.S. Provisional Patent Application 60/754,457 filed Dec. 28, 2005, the entirety of which is incorporated herein by reference.

### BACKGROUND OF THE INVENTION

The present invention relates to pad printing. More particularly, the present invention relates to printing identification marks with a pad printing device.

Pad printing devices are used to apply printing, e.g. trademarks and decorations, on non-flat surfaces. For example, pad printing devices can be used to print logos and the like on game balls such as golf balls. Such printing must be carried out on surfaces that are not only curved but irregular as well, e.g., on the dimpled surface of a golf ball.

Conventional pad printing methods have the disadvantage that the printing can easily be counterfeited. Pad printing that applies trademarks to products and the like is thus of little use in distinguishing genuine goods from counterfeit goods.

A taggant is an otherwise inert substance which can be mixed with an ink to convey information about an object upon which the ink is printed. Information conveyed by taggants may be detected by a variety of means, such as analysis of reflected light and chemical analysis. The information can include indicia of source, as well as batch numbers, ownership indicia, or the like. Many types of taggants are difficult to counterfeit even when the presence and general nature of the taggants is known, making taggants an effective means of source identification.

Some types of taggants can be configured in an effectively unlimited number of mutually distinguishable ways, and thus can be used to convey more detailed information. For example, such taggants can be used to identify each model of a product, or each batch or production run. The term “identification mark” is used herein to mean any mark that is printed on an object to convey information by means of an included taggant.

Taggants have not been used before in pad printing systems, or to print taggants on curved surfaces.

The general operation and principles of pad printing devices are further described in Kliest, U.S. Pat. Nos. 5,694,847 and 5,476,040 and Wohl et al., U.S. Pat. No. 5,000,694,839, which patents are commonly assigned with the present application and are incorporated herein by reference.

Accordingly, there is a need to advance the art.

### SUMMARY OF THE INVENTION

One aspect of the invention provides a method of applying an identification mark to a surface of a workpiece, comprising mixing a predetermined quantity of a taggant with a pad printing ink and applying the mixed taggant and pad printing ink to the surface of the workpiece with a pad printing device.

Another aspect of the invention provides a method of applying an identification mark to a surface of a workpiece, comprising receiving a quantity of a pad printing ink including a taggant, and applying a pad printing ink with included taggant to the surface of the workpiece with a pad printing device.

Another aspect of the invention provides a system for applying an identification mark to a surface of a workpiece, comprising means for receiving a quantity of a pad printing ink including a taggant and means for applying a pad printing ink with included taggant to the surface of the workpiece with a pad printing device.

The foregoing embodiments and other embodiments, objects, and aspects as well as features and advantages of the present invention will become further apparent from the following detailed description of various embodiments of the present invention. The detailed description and drawings are merely illustrative of the present invention, rather than limiting the scope of the present invention being defined by the appended claims and equivalents thereof.

### BRIEF DESCRIPTION OF THE DRAWINGS

FIG. 1 is a flowchart representation of a method which utilizes a separate pad printing ink and taggant in accordance with the present invention;

FIG. 2 is a flowchart representation of a method which utilizes a premixed pad printing ink and taggant according to the present invention; and

FIGS. 3A and 3B are schematic representations of a pad printing device which can be used to apply pad printing ink to a workpiece in either of the methods described herein.

### DETAILED DESCRIPTION OF THE INVENTION

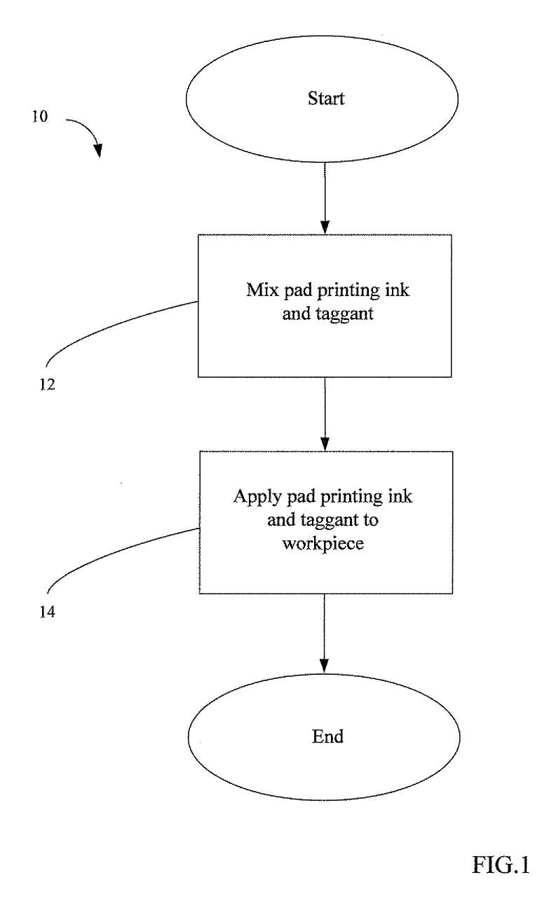

FIG. 1 illustrates a method 10 for applying an identification mark to a surface of a workpiece in accordance with one aspect of the invention.

A pad printing ink and a taggant are mixed in predetermined proportions at step 12. Mixing the pad printing ink and taggant can be implemented in any appropriate fashion, such as the addition of both elements to a container. A pad printing ink is any ink configured for usage with a pad printing system and configured to leave an substantially indelible mark on a workpiece.

In one embodiment, the pad printing ink and the taggant are supplied separately to the pad printing device and are mixed by the pad printing device. In another embodiment, the pad printing ink and the taggant are mixed outside the pad printing device and are supplied to the pad printing device in mixed form.

In step 14, the pad printing device applies the pad printing ink with the taggant included to a surface of a workpiece, thereby creating an identification mark.

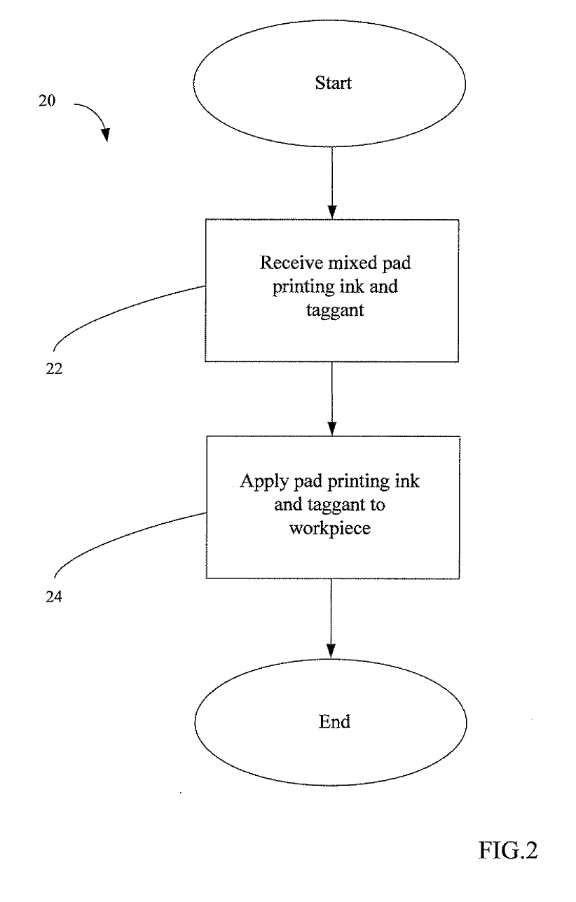

FIG. 2 illustrates another method 20 for applying an identification mark to a surface of a workpiece, in accordance with one aspect of the invention.

In step 22, a pad printing ink with a taggant included is received from a manufacturer or distributor. In step 24, the pad printing device applies the pad printing ink with the taggant included to a surface of a workpiece, thereby creating an identification mark.

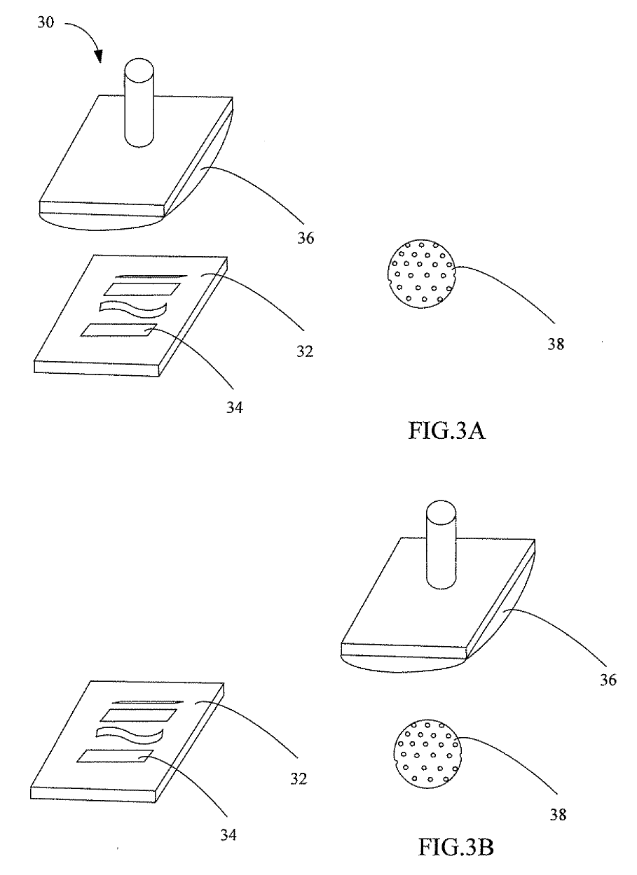

FIG. 3A illustrates one embodiment of a pad printing device 30 in accordance with one aspect of the invention. For example, pad printing device 30 can be used in steps 14 and 24 in the methods described above.

Pad printing device 30 includes a cliché plate including an imaging surface 32 and deformable pad 36. An image is formed on imaging surface 32 by applying pad printing ink to at least one image element 34 on the imaging surface 32. An image element 34 is an area on the imaging surface 32 which corresponds to a part of the printed image where ink will be deposited.

In one embodiment, image elements 34 are etched onto the imaging surface 32. In operation, the imaging surface 32 is covered with pad printing ink and wiped to remove excess ink after transferring the image to a deformable pad. The image elements 34 retain pad printing ink, while other parts of the imaging surface 32 are wiped clean. In another embodiment, the image is formed on the imaging surface 32 by depositing ink only on the image elements 34. After the image is formed on the imaging surface 32, the pad printing device presses a deformable pad 36 against the imaging surface 32, transferring the image from the imaging surface 32 to the deformable pad 36. FIG. 3A further illustrates workpiece 38.

FIG. 3B illustrates additional elements of the pad printing device illustrated in FIG. 3A, in accordance with another aspect of the invention. FIG. 3B illustrates deformable pad 36 in proximity to a workpiece 38. Deformable pad 36 includes the image to be transferred, and transfers the image from the deformable pad 36 to the workpiece 38. Because the surface of the deformable pad 36 conforms to the surface of the workpiece 38 under pressure, the deformable pad 36 transfers the entire image to the surface of the workpiece 38, regardless of the shape of the surface of the workpiece 38.

An embodiment of a pad printing device that deposits ink only on the imaging elements 34 of an imaging surface 34 is described in U.S. Patent Application No. (Attorney Docket 15633 1231/3), which application is filed concurrently with the present application and commonly assigned with the present application, and is incorporated herein by reference.

Taggants can be used overtly in functional marks, whose security function is apparent to the unaided eye. In this type of application, presence of an identification mark, for example, is a product feature, increasing the value or attractiveness of the object that is so marked, such as with a trademark. Alternatively, taggants can be used covertly in decorative marks, whose security function is not apparent to the unaided eye, and in invisible marks, whose existence is not apparent to the unaided eye.

While the embodiments of the present invention disclosed herein are presently considered to be preferred embodiments, various changes and modifications can be made without departing from the spirit and scope of the present invention. The scope of the invention is indicated in the appended claims, and all changes that come within the meaning and range of equivalents are intended to be embraced therein.

What is claimed is:

1. A method of applying an identification mark to a surface of a workpiece, comprising:
mixing a taggant with a pad printing ink in predetermined proportions; and
applying the pad printing ink with the taggant included to the surface of the workpiece.

2. The method of claim 1, wherein the applied pad printing ink with the taggant is a decorative mark.

3. The method of claim 1, wherein the applied pad printing ink with the taggant is a functional mark.

4. The method of claim 1, wherein the applied pad printing ink with the taggant is an invisible mark.

5. The method of claim 1, wherein the applied pad printing ink with the taggant is indicative of the source of the workpiece.

6. The method of claim 1, wherein the applied pad printing ink with the taggant is indicative of a batch number.

7. The method of claim 1, wherein applying the pad printing ink comprises:
forming an image on an imaging surface by applying pad printing ink including the taggant to at least one image element on the imaging surface;
transferring the image to a surface of a deformable pad by pressing the deformable pad against the imaging surface; and
transferring the image to a surface of a workpiece by pressing the deformable pad against the workpiece.

8. A method of applying an identification mark to a surface of a workpiece, comprising:
receiving a pad printing ink including a taggant; and
applying the pad printing ink with the taggant included to the surface of the workpiece.

9. The method of claim 8, wherein the applied pad printing ink with the taggant is a decorative mark.

10. The method of claim 8, wherein the applied pad printing ink with the taggant is a functional mark.

11. The method of claim 8, wherein the applied pad printing ink with the taggant is an invisible mark.

12. The method of claim 8, wherein the applied pad printing ink with the taggant is indicative of the source of the workpiece.

13. The method of claim 8, wherein the applied pad printing ink with the taggant is indicative of a batch number.

14. The method of claim 8, wherein applying the pad printing ink comprises:
forming an image on an imaging surface by applying pad printing ink to at least one imaging element on the imaging surface;
transferring the image to a surface of a deformable pad by pressing the deformable pad against the imaging surface; and
transferring the image to a surface of a workpiece by pressing the deformable pad against the workpiece.

15. A system for applying an identification mark to a surface of a workpiece, wherein the system comprises:
means for receiving a quantity of ink including a taggant; and
means for applying the ink to the surface of the workpiece with a pad printing device.

16. A method of applying an identification mark to a curved surface of a workpiece, comprising:
mixing a taggant with an ink in predetermined proportions; and
applying the ink with the taggant included to the curved surface of the workpiece.

17. The method of claim 16 wherein the ink with the taggant included is applied to the curved surface with a pad printing device.

18. An object comprising:
a curved surface on an exterior of the object, and
an image on at least a portion of the curved surface, the image formed with ink, the ink including at least one taggant.

19. The object of claim 18 wherein the ink including at least one taggant is applied to the object with a pad printing device.
